(19) United States
(12) Patent Application Publication
(10) Pub. No.: US 2015/0142629 A1
(43) Pub. Date: May 21, 2015

(54) DETECTING UNUSUAL ACTIVITY IN CASH VAULT TRANSACTIONS

(71) Applicant: Bank of America Corporation, Charlotte, NC (US)

(72) Inventors: Carl Suplee, Hunterville, NC (US); Cameron Blake Hughes, Charlotte, NC (US); Jun Zhou, Charlotte, NC (US); Xiaowei Ying, Charlotte, NC (US)

(73) Assignee: Bank of America Corporation, Charlotte, NC (US)

(21) Appl. No.: 14/085,580

(22) Filed: Nov. 20, 2013

(51) Int. Cl. G06Q 20/40

(52) U.S. Cl. CPC G06Q 20/4016
USPC 705/35

(57) ABSTRACT

In some embodiments, a system includes an interface and one or more processors communicatively coupled to the interface. The interface receives current transaction information indicating a proportion of large denomination currency transacted by a customer during a current period. The processors determine historic transaction information and a dynamic threshold for the customer. The historic transaction information indicates a proportion of large denomination currency transacted by the customer during a historic period. The dynamic threshold is based on the historic transaction information and indicates whether a change in the proportion of large denomination currency transacted by the customer is unusual. If the current transaction information exceeds the dynamic threshold, the processors generate an alert and the interface communicates the alert.

### TECHNICAL FIELD OF THE INVENTION

This invention relates generally to monitoring techniques, and more particularly to detecting unusual activity in cash vault transactions.

### BACKGROUND

Banks and other financial institutions may provide cash vault services to customers. A cash vault service processes physical cash comprising currency in various denominations, such as one, five, ten, twenty, fifty, and one hundred dollar bills. As an example, a cash vault service may pick up cash from a customer location, transport the cash to a cash vault using an armored vehicle, verify the amount, deposit the cash in the cash yank, and credit the customer's account.

### SUMMARY

According to embodiments of the present disclosure, disadvantages and problems associated with detecting unusual activity in cash vault transactions may be reduced or eliminated.

In some embodiments, a system includes an interface and one or more processors communicatively coupled to the interface. The interface receives current transaction information indicating a proportion of large denomination currency transacted by a customer during a current period. The processors determine historic transaction information and a dynamic threshold for the customer. The historic transaction information indicates a proportion of large denomination currency transacted by the customer during a historic period. The dynamic threshold is based on the historic transaction information and indicates whether a change in the proportion of large denomination currency transacted by the customer is unusual. If the current transaction information exceeds the dynamic threshold, the processors generate an alert and the interface communicates the alert.

Certain embodiments of the present disclosure may provide one or more technical advantages. A technical advantage of one embodiment includes detecting unusual cash vault activity accurately and efficiently. For example, certain embodiments may apply a dynamic threshold customized to an individual customer to determine if an increase in the proportion of large bills that the customer deposits to a cash vault is unusual. A technical advantage of one embodiment includes looking at changes in the proportions of a customer's transactions (i.e., a value between 0% and 100%) as opposed to changes in the customer's overall dollar amount (which has no hard upper limit). Using a proportion hound between 0% and 100% may allow for efficient comparison to typical historic behavior of the customer and/or comparable customers. One or more other technical advantages may be readily apparent to those skilled in the art from the figures, descriptions, and claims included herein.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of a system for detecting unusual activity in cash vault transactions;

FIG. 2 illustrates an example flowchart for detecting unusual activity in cash vault transactions; and

FIG. 3 illustrates an example graph of a dynamic threshold for detecting unusual activity in cash vault transactions.

### DETAILED DESCRIPTION OF THE DRAWINGS

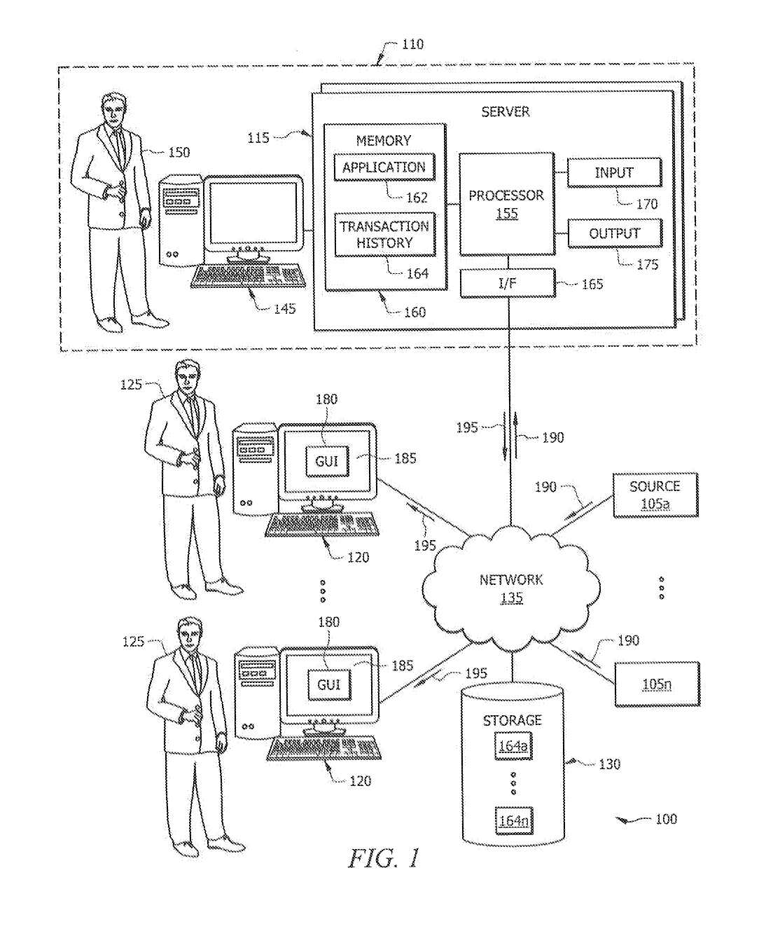

Embodiments of the present invention and its advantages are best understood by referring to FIGS. 1 through 3 of the drawings, like numerals being used for like and corresponding parts of the various drawings.

Banks and other financial institutions may provide cash vault services to customers. A cash vault service processes physical cash comprising currency in various denominations, such as one, five, ten, twenty, fifty, and one hundred dollar bills. As an example, a cash vault service may pick up cash from a customer location, transport the cash to a cash vault using an armored vehicle, verify the amount, deposit the cash in the cash vault, and credit the customer's account.

Anti-money laundering scenarios may monitor cash vault transactions to identify suspicious activity. Conventional scenarios may identify customer activity as suspicious if the total dollar amount of a deposit and/or the frequency with which the customer makes deposits increase by a fixed amount. Such scenarios may fail to detect certain money laundering behaviors. Embodiments of the present disclosure may provide a solution to this and other problems. In some embodiments, anti-money laundering scenarios review a customer's historic cash vault deposits to identify any significant changes in the customer's behavior patterns. For example, the customer's historic cash vault deposits may be reviewed to calculate the proportion of the deposits comprised of large denominations of currency (e.g., $50 and $100 bills). The historic proportion of large denominations of currency may be compared to the customer's current proportion of large denominations of currency. An alert may be generated if the customer exhibits a significant increase in the proportion of large denominations of currency transacted. To determine whether an increase is significant, the anti-money laundering scenario may apply a dynamic threshold based on the historic activity of the individual customer, as further discussed with respect to FIGS. 1-3 below.

FIG. 1 illustrates an example block diagram of a system 100 for detecting unusual activity in cash vault transactions. System 100 may include one or more sources 105, an enterprise 110 comprising one or more servers 115, one or more clients 120 associated with one or more users 125, and a network storage device 130. Sources 105, enterprise 110, servers 115, clients 120, and network storage device 130 may be communicatively coupled by a network 135. In general, source 105 may provide a server 115 of enterprise 110 with current transaction information 190 indicating a proportion of large denomination currency transacted by a customer during a current period. Server 115 compares current transaction information 190 to the proportion of large denomination currency that the customer transacted during a historic period. If the proportion of large denomination currency transacted by the customer has increased beyond a dynamic threshold, server 115 generates an alert 195 and provides alert 195 to users 125 via client 120.

Client 120 may refer to any device that enables user 125 to interact with server 115. In some embodiments, client 120 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 120 may also comprise any suitable user interface such as a display 185, microphone, keyboard, or any other appropriate terminal equipment usable by a user 125. It will be understood that system 100 may comprise any number and combination of clients 120. User 125 utilizes client 120 to interact with server 115 to receive alert 195, as described below. In some embodiments, user 125 may be an employee of a financial institution, an investigative business, or a governmental entity that monitors transactions to detect activity that raises a suspicion that the customer is laundering money, such as unusual activity in cash vault transactions.

In some embodiments, client 120 may include a graphical user interface (GUI) 180. GUI 180 is generally operable to tailor and filter data entered by and presented to user 125. GUI 180 may provide user 125 with an efficient and user-friendly presentation of current transaction information 190 and/or alert 195. GUI 180 may comprise a plurality of displays having interactive fields, pull-down lists, and buttons operated by user 125. GUI 180 may include multiple levels of abstraction including groupings and boundaries. It should be understood that the term GUI 180 may be used in the singular or in the plural to describe one or more GUIs 180 and each of the displays of a particular GUI 180.

In some embodiments, network storage device 130 may refer to any suitable device communicatively coupled to network 135 and capable of storing and facilitating retrieval of data and/or instructions. Examples of network storage device 130 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 130 may store any data and/or instructions utilized by server 115. In the illustrated embodiment, network storage device 130 stores transaction history 164. Transaction history 164 may include data describing previous transactions by the customer associated with current transaction information 190. For each transaction, transaction history 164 may include a transaction number, account number, customer identifier, transaction date, dollar amount, a proportion of large denomination currency, and/or other suitable information. Transaction history 164 may be analyzed to determine whether the proportion of large denomination currency transacted by the customer during a current period demonstrates an unusual increase relative to the customer's historic behavior.

In certain embodiments, network 135 may refer to any interconnecting system capable of transmitting audio, video, signals, data, messages, or any combination of the preceding. Network 135 may include all or a portion of a public switched telephone network (PSTN), a public or private data network, a local area network (LAN), a metropolitan area network (MAN), a, wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 115, an administrator workstation 145, and an administrator 150, in some embodiments, server 115 may refer to any suitable combination of hardware and/or software implemented in one or more modules to process data and provide the described functions and operations. In some embodiments, the functions and operations described herein may be performed by a pool of servers 115. In some embodiments, server 115 may include, for example, a mainframe, server, host computer, workstation, web server, file server, a personal computer such as a laptop, or any other suitable device operable to process data. In some embodiments, server 115 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 115 compares a current proportion of large denomination currency transacted by the customer with a historic proportion of large denomination currency transacted by the customer. If the proportion of large denomination currency transacted by the customer has increased beyond a dynamic threshold, server 115 generates an alert 195 and provides alert 195 to users 125 via client 120. In some embodiments, servers 115 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 115, it should be understood that server memory 160 may be internal or external to server 115, depending on particular implementations. Also, server memory 160 may be separate from or integral to other memory devices to achieve any suitable arrangement of memory devices for use in system 100.

Server memory 160 is generally operable to store an application 162 and transaction history 164. Application 162 generally refers to logic, rules, algorithms, code, tables, and/or other suitable instructions for performing the described functions and operations. In some embodiments, application 162 facilitates generating alert 195 and communicating alert 195 to users 125.

Server memory 160 communicatively couples to processor 155. Processor 155 is generally operable to execute application 162 stored in server memory 160 to provide alert 195 according to the disclosure. Processor 155 may comprise any suitable combination of hardware and software implemented in one or more modules to execute instructions and manipulate data to perform the described functions for servers 115. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 115, send output from server 115, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through network 135 or other communication system that allows server 115 to communicate to other devices. Communication interface 165 may include any suitable software operable to access data from various devices such as clients 120 and/or network storage device 130. Communication interface 165 may also include any suitable software operable to transmit data to various devices such as clients 120 and/or network storage device 130. Communication interface 165 may include one or more ports, conversion software, or both. In general, communication interface 165 receives current transaction information 190 from source 105 and transmits alert 195 to clients 120.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 115 using an administrator workstation 145. In some embodiments, administrator workstation 145 may be communicatively coupled to server 115 and may refer to any suitable computing system, workstation, personal computer such as a laptop, or any other device operable to process data. In certain embodiments, an administrator 150 may utilize administrator workstation 145 to manage server 115 and any of the data stored in server memory 160 and/or network storage device 130.

In operation, application 162, upon execution by processor 155, facilitates generating alert 195 and offers alert 195 to users 125. Alert 195 indicates an unusual increase in the proportion of large denomination currency transacted by the customer. Alert 195 may be determined according to a dynamic threshold. The dynamic threshold may be configured according to the particular customer's historic activity such that each customer is independently evaluated against the customer's own activity. Thus, if the customer's activity changes gradually over time, the threshold may adjust to reflect the now-typical behavior for the customer. If, however, the customer's activity changes abruptly, application 162 may generate an alert.

To provide alert 195, application 162 may first receive current transaction information 190 from source 105. Source 105 may monitor cash vault transactions and generate current transaction information 190, such as a transaction number, account number, customer identifier, transaction date, dollar amount, a proportion of large denomination currency, and/or other suitable information. Although FIG. 1 illustrates source 105 as external to enterprise 110, it should be understood that source 105 may be internal or external to enterprise 110, depending on particular implementations.

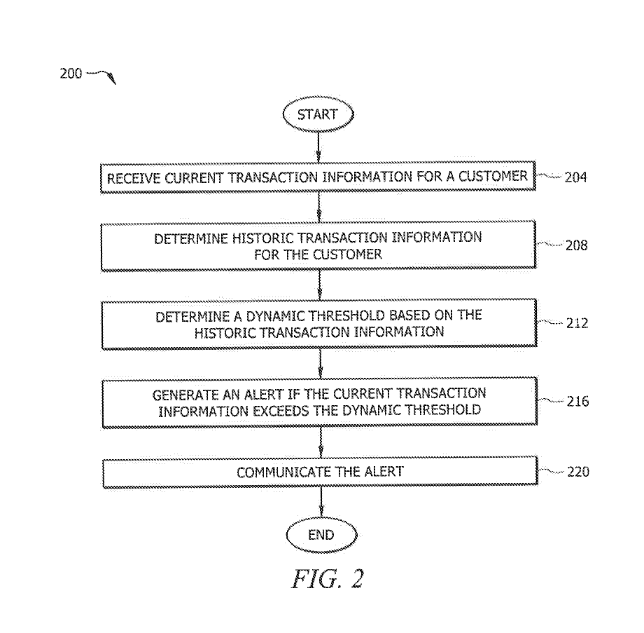

Once application 162 receives current transaction information 190, application 162 may determine whether to generate alert 195. In general application 162 may determine historic transaction information for the customer associated with current transaction information 190. For example, application 162 may retrieve transaction history 164 associated with the customer based on any suitable identifier, such as name, account number, etc. Application 162 may determine a dynamic threshold for the customer based on the historic transaction information. The dynamic threshold indicates whether a change in the proportion of large denomination currency transacted by the customer is unusual. Application 162 may generate an alert if current transaction information 190 exceeds the dynamic threshold and may then communicate alert 195 to user 125. FIG. 2 below provides a detailed example of a method that application 162 may perform to communicate alert 195.

FIG. 2 illustrates an example method 200 for detecting unusual activity in cash vault transactions. The method begins at step 204 by receiving current transaction information for a customer. The current transaction information includes information associated with cash vault transactions transacted during a current period. The current period corresponds to a time period being monitored for suspicious activity. Any suitable time period may be selected for the current period, such as one day, one week, one month, two months, three months, six months, one year, and so on. The current transaction information may include transaction number(s), an account number, a customer identifier, transaction date(s), dollar amount(s), proportion of large denomination currency, and/or other suitable information.

In some embodiments, large denomination currency may refer to currency having a value greater than or equal to $50 (e.g., $50 bills, $100 bills). The proportion of large denomination currency may be determined in any suitable manner, such as according to a number of large denomination bills or according to monetary value. As an example, suppose a customer transacted a $1,500 deposit comprising 8 five dollar bills, 20 ten dollar bills, 3 twenty dollar bills, 4 fifty dollar bills, and 10 one hundred dollar bills. The proportion of large denomination currency may be calculated as 0.311 using a number of large denomination bills calculation, which takes the total number of large bills (4+10) and divides by the total number of bills (8+20+3+4+10). In the alternative, the proportion of large denomination currency may be calculated as 0.8 using a monetary value calculation, which takes the monetary value attributed to the large bills ((4×$50)+(10×$100)) and divides by the total monetary value of the transaction ($1,500).

At step 208, the method determines historic transaction information for the customer. The historic transaction information indicates a proportion of large denomination currency transacted by the customer during a historic period. The historic period may refer to a period immediately prior to the current period. As an example, the current period may be configured as the one month period from Nov. 1 to Nov. 30, 2013, and the historic period may be configured as the one year period immediately prior to the current period (Nov. 1, 2012 to Oct. 31, 2013). The proportion of large denomination currency transacted during the historic period may be calculated according to the same technique used to calculate the proportion of large denomination currency transacted during the current period. For example, a number of large denomination bills technique may be used to calculate both the historic proportion during the historic period and the current proportion during the current period.

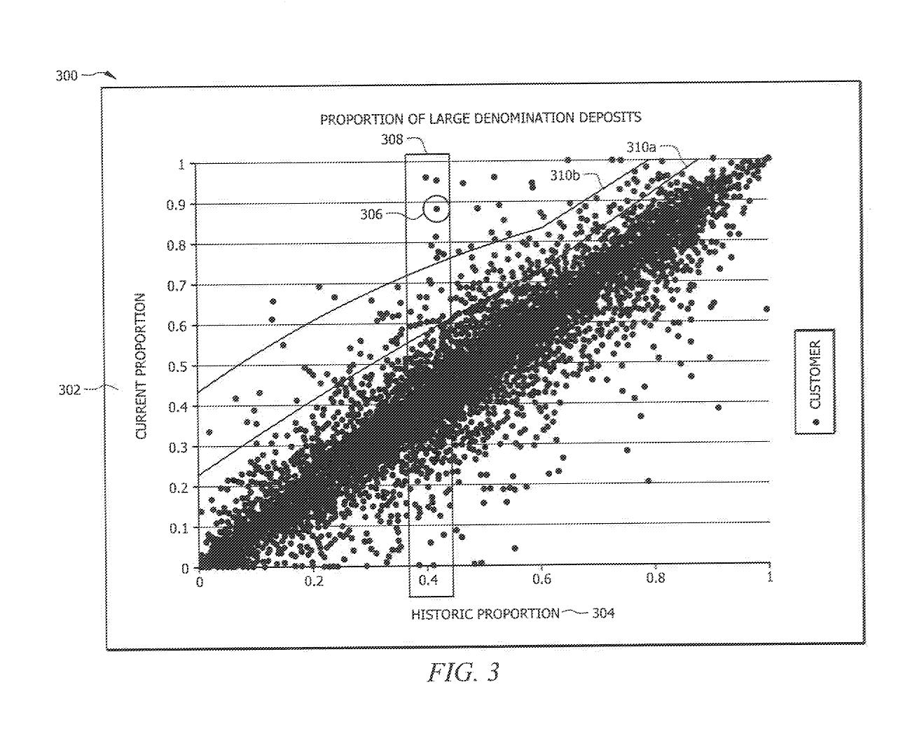

The method determines a dynamic threshold for the customer at step 212. The dynamic threshold indicates whether a change in the proportion of large denomination currency transacted by the customer is unusual. The dynamic threshold may be determined for the individual customer based on the customer's historic transaction information. In some embodiments, the dynamic threshold may be configured as a parametric curve, for example, where the coordinates of the points of the curve are expressed as functions of the historic proportion variable (i.e., the proportion of large denomination currency transacted during the historic period). In some embodiments, the dynamic threshold may be based in part on the proportion of large denomination currency transacted by comparable customers during the current period. Comparable customers may refer to customers that transacted a similar proportion of large denomination currency as the customer during the historic period. The dynamic threshold may characterize an increase corresponding to a particular percentile relative to the comparable customers as unusual, such as the 95th percentile. An example of the dynamic threshold is described in more detail with respect to FIG. 3 below.

In some embodiments, the dynamic threshold is further configured according to a minimum increment such that if the increase in the proportion of large denomination currency transacted by the customer is less than the minimum increment, the increase is not characterized as unusual. The minimum increment decreases as the proportion of large denomination currency transacted by the customer during the historic period increases. A reason for varying the minimum increment is that it may not be unusual for a customer that has a history of low large bill proportions to require a larger increase in large bills than a customer with a history of high large bill proportions. As an example, a customer who historically has only deposited 10% in large bills has more room to grow than a customer who has historically deposited 50% in large bills. A 20% difference in the proportion of large bills may be relatively low risk for the customer that historically deposited 10% in large bills and now deposits 30% in large bills. However, a 20% difference in the proportion of large bills may be relatively high risk for the customer that historically deposited 50% in large bills and now deposits 70% in large bills. In the example, the minimum increment may be set to 20% for customers with historic proportions of large bills in the 10% range, and the minimum increment may be set lower (e.g., 5%) for customers with historic proportions of large bills in the 50% range.

At step 216, the method generates an alert if the current transaction information exceeds the dynamic threshold and, at step 220, the method communicates the alert. The alert may contain any suitable information, such as transaction number(s), an account number, a customer identifier, transaction date(s), dollar amount(s), a proportion of large denomination currency, and/or other suitable information. In some embodiments, the alert may include a risk level, such as a risk category (e.g., (high, medium, low) or (red, yellow, green) or (A, B, C)) and/or a numerical value indicating a level of risk (e.g., 90th percentile, 80 points, etc.). The risk level may be based on the increase in the proportion of large bills alone, or it may take other risk factors into consideration (e.g., if the customer has been flagged for other types of risk, such as payment layering or transaction structuring). The method then ends.

FIG. 3 illustrates an example graph of a dynamic threshold 310 for detecting unusual activity in cash vault transactions. The graph includes a current proportion 302 along the y-axis, a historic proportion 304 along the x-axis, customer transaction information 306, comparable customer transaction information 308, first dynamic threshold 310a, and second dynamic threshold 310b. In the example, a determination is made whether to generate an alert for the customer corresponding to customer transaction information 306.

Looking at customer transaction information 306 relative to current proportion 302 indicates that the proportion of large denomination currency transacted by the customer during the current period (e.g., the current month) is nearly 90%. Looking at customer transaction information 306 relative to historic proportion 304 indicates that the proportion of large denomination currency transacted by the same customer during the historic period (e.g., 1 year immediately prior to the current period) is approximately 40%.

To determine the dynamic thresholds 310a and 310b for the particular customer, comparable customer transaction information 308 may be used. Comparable customer transaction information corresponds to customers that transacted a similar proportion of large denomination currency as the customer during the historic period. Any suitable additional information may optionally be used to determine comparable customers, such as customer type (individual or business) or aggregate monetary value transacted during the historic period (e.g., two customers that each transacted 40% in large bills during the historic period may or may not be comparable if one of the customers transacted $10,000 and the other transacted $10,000,000 during the historic period).

As discussed above, the customer associated with customer transaction information 306 transacted a proportion of approximately 40% large denomination currency during the historic period. This means that the customer's comparable customers also transacted a proportion of approximately 40% large denomination currency during the historic period (as shown by historic proportion 304). The concentration of dots in FIG. 3 shows that most of the comparable customers continued to transact approximately 40% large denomination currency during the current period (e.g., according to current proportion 302).

The dynamic thresholds 310 may be configured to capture an unusually large increase in the customer's current proportion 302 as compared to the increases associated with the current proportions 302 of the comparable customers (customers with similar historic proportions as the customer being evaluated). As an example, dynamic threshold 310a may be configured to capture transactions in the 90th percentile and dynamic threshold 310b may be configured to capture transactions in the 95th percentile of increases in the proportion of large denomination currency transactions. Customers corresponding to large bill increases less than dynamic threshold 310a may not cause any alert to be generated. Customers corresponding to large bill increases greater than dynamic threshold 310a and less than dynamic threshold 310b may cause a lower risk alert to be generated. Customers corresponding to large bill increases greater than dynamic threshold 310b may cause a higher risk alert to be generated.

As can be seen in FIG. 3, dynamic thresholds 310 are customized to each customer's historic activity. For example, a first customer with a historic proportion 304 set to 10% would have to demonstrate a current proportion 302 of over 50% to generate a higher risk alert according to dynamic threshold 310b. By contrast, a second customer with a historic proportion 304 set to 60% would have to demonstrate a current proportion 302 of approximately 85% to generate a higher risk alert according to dynamic threshold 310b. Thus, the first customer must increase the proportion of large bills transacted by a factor of 5 in order to generate a high risk alert, whereas the second customer only requires increasing the proportion of large bills transacted by a factor of about 1.417 to generate the high risk alert.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

What is claimed is:

1. A system, comprising:
an interface operable to receive current transaction information indicating a proportion of large denomination currency transacted by a customer during a current period; and
one or more processors communicatively coupled to the interface, the one or more processors are operable to:
determine historic transaction information indicating a proportion of large denomination currency transacted by the customer during a historic period;
determine a dynamic threshold for the customer based on the historic transaction information, the dynamic threshold indicating whether a change in the proportion of large denomination currency transacted by the customer is unusual; and
generate an alert if the current transaction information exceeds the dynamic threshold;
the interface further operable to communicate the alert.

2. The system of claim 1, wherein the current period corresponds to a one month period being monitored for suspicious activity and the historic period corresponds to a one year period immediately prior to the current period.

3. The system of claim 1, wherein each large denomination currency has a value greater than or equal to $50.

4. The system of claim 1, wherein the dynamic threshold is further configured according to a minimum increment such that if the increase in the proportion of large denomination currency transacted by the customer is less than the minimum increment, the increase is not characterized as unusual.

5. The system of claim 4, wherein the minimum increment decreases as the proportion of large denomination currency transacted by the customer during the historic period increases.

6. The system of claim 1, the one or more processors further operable to:
determine a plurality of comparable customers, wherein each comparable customer transacted a similar proportion of large denomination currency as the customer during the historic period; and
configure the dynamic threshold based in part on the proportion of large denomination currency transacted by the comparable customers during the current period.

7. The system of claim 6, wherein the one or more processors configure the dynamic threshold to characterize an increase in the 95th percentile relative to the comparable customers as unusual.

8. Non-transitory computer readable medium comprising logic, the logic, when executed by a processor, operable to:
receive current transaction information indicating a proportion of large denomination currency transacted by a customer during a current period;
determine historic transaction information indicating a proportion of large denomination currency transacted by the customer during a historic period;
determine a dynamic threshold for the customer based on the historic transaction information, the dynamic threshold indicating whether a change in the proportion of large denomination currency transacted by the customer is unusual;
generate an alert if the current transaction information exceeds the dynamic threshold; and
communicate the alert.

9. The computer readable medium of claim 8, wherein the current period corresponds to a one month period being monitored for suspicious activity and the historic period corresponds to a one year period immediately prior to the current period.

10. The computer readable medium of claim 8, wherein each large denomination currency has a value greater than or equal to $50.

11. The computer readable medium of claim 8, the logic further operable to configure the dynamic threshold according to a minimum increment such that the increase in the proportion of large denomination currency transacted by the customer is not characterized as unusual if the increase is less than the minimum increment.

12. The computer readable medium of claim 11, wherein the minimum increment decreases as the proportion of large denomination currency transacted by the customer during the historic period increases.

13. The computer readable medium of claim 8, the logic further operable to:
determine a plurality of comparable customers, wherein each comparable customer transacted a similar proportion of large denomination currency as the customer during the historic period; and
configure the dynamic threshold based in part on the proportion of large denomination currency transacted by the comparable customers during the current period.

14. The computer readable medium of claim 13, wherein the logic is further operable to configure the dynamic threshold to characterize an increase in the 95th percentile relative to the comparable customers as unusual.

15. A method, comprising:
receiving current transaction information indicating a proportion of large denomination currency transacted by a customer during a current period;
determining historic transaction information indicating a proportion of large denomination currency transacted by the customer during a historic period;
determining, by a processor, a dynamic threshold for the customer based on the historic transaction information, the dynamic threshold indicating whether a change in the proportion of large denomination currency transacted by the customer is unusual;
generating an alert if the current transaction information exceeds the dynamic threshold; and
communicating the alert.

16. The method of claim 15, wherein the current period corresponds to a one month period being monitored for suspicious activity and the historic period corresponds to a one year period immediately prior to the current period.

17. The method of claim 15, wherein each large denomination currency has a value greater than or equal to $50.

18. The method of claim 15, further comprising configuring the dynamic threshold according to a minimum increment such that the increase in the proportion of large denomination currency transacted by the customer is not characterized as unusual if the increase is less than the minimum increment.

19. The method of claim 18, wherein the minimum increment decreases as the proportion of large denomination currency transacted by the customer during the historic period increases.

20. The method of claim 15, further comprising:
determining a plurality of comparable customers, wherein each comparable customer transacted a similar proportion of large denomination currency as the customer during the historic period; and
configuring the dynamic threshold based in part on the proportion of large denomination currency transacted by the comparable customers during the current period.
